(19) United States
(12) Patent Application Publication
(10) Pub. No.: US 2007/0187018 A1
(43) Pub. Date: Aug. 16, 2007

(54) Method and apparatus for producing tyres for vehicle wheels

(76) Inventors: Claudio Lacagnina, Milano (IT); Ignazio De Gese, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/565,632

(22) PCT Filed: Jul. 30, 2003
(86) PCT No.: PCT/IT03/00478

§ 371 Date: Jun. 30, 2006

(51) Int. Cl. B29D 30/20

(52) U.S. Cl. 156/111; 156/130; 156/396

(57) ABSTRACT

A method for producing a tyre for a vehicle wheel includes disposing a carcass structure on a drum having distal and proximal halves; disposing a belt structure around the carcass structure; moving the distal and proximal halves mutually close, from a building condition to a shaping condition, until an intermediate portion of the carcass structure contacts an inner surface of the belt structure; and transferring the drum, in the shaping condition, to a vicinity of at least one application unit. The distal and proximal halves are both carried by a support structure. During moving the distal and proximal halves mutually close, the proximal half maintains a fixed axial position with respect to the support structure. The at least one unit applies at least one elongated element of elastomeric material, in circumferential coils, to form at least one component of the tyre external to the carcass structure.

The present invention relates to a method of producing tyres for vehicle wheels, and to an apparatus for vehicle-tyre production to be used for carrying out said method.

A tyre for vehicle wheels generally comprises a carcass structure including at least one carcass ply having respectively opposite end flaps turned up around annular anchoring structures, each usually formed of a substantially circumferential annular insert onto which at least one filling insert is applied, at a radially external position.

Associated with the carcass structure is a belt structure comprising one or more belt layers placed in radial overlapped relationship with respect to each other and to the carcass ply and having textile or metallic reinforcing cords of a crossed orientation and/or an orientation substantially parallel to the circumferential extension direction of the tyre. At a radially external position to the belt structure, a tread band is applied which is made of elastomeric material like other semi-finished products constituting the tyre itself.

It is to be pointed out here that within the present specification and in the subsequent claims by the term “elastomeric material” it is intended a composition comprising at least one elastomeric polymer and at least one reinforcing filler. Preferably this composition further comprises additives such as a cross-linking and/or plasticizing agent, for example. Due to the presence of the cross-linking agent, this material can be cross-linked through heating so as to form the final article of manufacture. In addition, respective sidewalls of elastomeric material, each extending from one of the side edges of the tread band until close to the respective annular anchoring structure to the beads, are applied to the side surfaces of the carcass structure, which sidewalls depending on the different embodiments, may have respective radially external end edges superposed on the side edges of the tread band so as to form a design scheme of the type usually referred to as “overlying sidewalls”, or interposed between the carcass structure and the side edges of the tread band itself, in accordance with a design scheme of the type referred to as “underlying sidewalls”.

As shown in documents U.S. Pat. No. 3,990,931 and EP 0 613 757 for example, in most of the known processes for building a tyre the carcass structure and belt structure, together with the respective tread band, are provided to be made separately of each other in respective work stations, to be mutually assembled later on.

In the traditional building methods illustrated in the previously mentioned documents, the tread band is usually made of a continuously-extruded section member that, after being cooled to stabilise its geometrical conformation, is stored on appropriate tables or reels. The semifinished product in the form of sections or of a continuous strip is then sent to a feeding unit the task of which is either to pick up the cut sections or to cut sections of predetermined length from the continuous strip, each of them constituting the tread band to be circumferentially applied to the belt structure of a tyre being processed.

Document EP 1 211 057 A2 discloses a method of producing a tyre wherein during formation of a green tyre, at least one constituent element such as a sidewall is formed by shaping a central portion of a substantially cylindrical carcass structure radially outwardly and subsequently winding up an unvulcanized rubber strip joining it to an outer peripheral surface of the shaped carcass structure.

Document EP 1 201 414 A2 discloses a method of producing a tyre comprising: assembling unvulcanized rubber components to form a green tyre, vulcanizing the green tyre and winding an unvulcanized rubber ribbon in such a manner that windings as a whole will have a predetermined shape in cross-section for at least one of the unvulcanized rubber components to thereby form at least one of said components of unvulcanized rubber. In the production contexts to which the present invention addresses and involving production and storage of semifinished products and subsequent assembling of same on a building and/or shaping drum, production of the tread bands and sidewalls presently calls for installation of a drawing equipment that, to be able to supply appropriate advantages in terms of large-scale economy, must necessarily have a high productivity.

The Applicant realized the possibility of achieving important improvements in terms of production flexibility and quality of the product, in the present processes of tyre building through assembling of semi-finished components, by producing the tread band and/or sidewalls through winding of a continuous elongated element into circumferential coils directly on a green tyre under production and shaped in a substantially toroidal conformation. In more detail, the Applicant thought of resorting to use of a robotized apparatus to support a drum carrying the carcass structure so as to lead said structure to interact with the units intended for application of the belt structure and formation of the tread band, sidewalls and/or other inserts or structural components provided in the tyre assembling process. Note that this drum can be a building and shaping drum i.e. a so-called “unistage” drum in which the carcass structure is built directly on it and subsequently shaped for association of same with a belt structure. Alternatively, said drum can be a shaping drum also referred as “second-stage drum” on which a carcass structure previously made in the form of a cylindrical sleeve is shaped into a toroidal conformation for association with a belt structure.

The Applicant felt the requirement and possibility of lightening and simplifying the structure of said drum, in particular to make it specifically suitable for an automated control of the movements such as those executed through a robotized apparatus, for example.

The Applicant in fact could verify that the structural complexity, weights and overall dimensions of the presently used drums are not very compatible with control of the latter by a robotized apparatus.

More specifically, in said drums for carrying out the shaping step necessary to associate the belt structure with the carcass structure, an axial and substantially symmetric movement of the two halves of which the drums are made is required, which movement is only obtainable by means of a heavy and complicated mechanical structure that hardly adapts itself to the above discussed movement control, due to its overall dimensions. In accordance with the present invention, the Applicant realized the possibility of overcoming the above described problems by arranging a building apparatus in which the proximal drum half is rigidly fixed with respect to a movable support structure, whereas the distal drum half is set to carry out a relative double stroke as compared with that carried out by the proximal half.

In accordance with a first aspect, the invention comprises a method of producing tyres for vehicle wheels comprising the steps of: disposing a carcass structure having the shape of a cylindrical sleeve on a drum consisting of a distal half and a proximal half both carried by a support structure; disposing a belt structure coaxially around the carcass structure; moving the proximal and distal halves mutually close, from a building condition to a shaping condition, to cause a radial expansion of an intermediate portion of the carcass structure until bringing said intermediate portion into contact with an inner surface of the belt structure, in which during mutual moving close of the proximal and distal halves, the proximal half keeps a fixed axial positioning with respect to the support structure; transferring said drum in the shaping condition in front of at least one unit for application of at least one elongated element of elastomeric material in the form of circumferential coils, which unit is adapted to form at least one component of said tyre at a position radially external to said belt structure or axially external to said carcass structure.

It was found in fact that an important lightening and structural simplification of said drum can thus be achieved, making mounting of same on a robotized apparatus easier. The typical mobility of a robotized apparatus comprising at least one robotized arm for example, can possibly be utilised to keep the middle plane between the halves steady, and consequently also the carcass structure relative to the belt structure, on mutual moving of the halves themselves close to each other during the shaping step. Alternatively, the relative movements between the belt structure and carcass structure can be cancelled by moving the belt structure to the proximal drum half, while the distal drum half is moved towards the proximal half itself.

In a further aspect, the invention relates to an apparatus for producing tyres for vehicle wheels, comprising: a drum having a distal half and a proximal half both carried by a support structure; transfer devices to dispose a belt structure coaxially around a carcass structure set on the drum in the form of a cylindrical sleeve; translation devices to move the proximal and distal halves close to each other from a building condition to a shaping condition; at least one unit for application of an elongated element of elastomeric material, set to interact with said drum so as to obtain laying of said elongated element in circumferential coils externally of the carcass structure, to make at least one component of said tyre; wherein the proximal half is axially fixed with respect to the support structure.

Further features and advantages will become more apparent from the detailed description of a preferred but not exclusive embodiment of a method and an apparatus for producing tyres for vehicle wheels, in accordance with the present invention.

This description will be set out hereinafter with reference to the accompanying drawings, given by way of non-limiting example, in which:

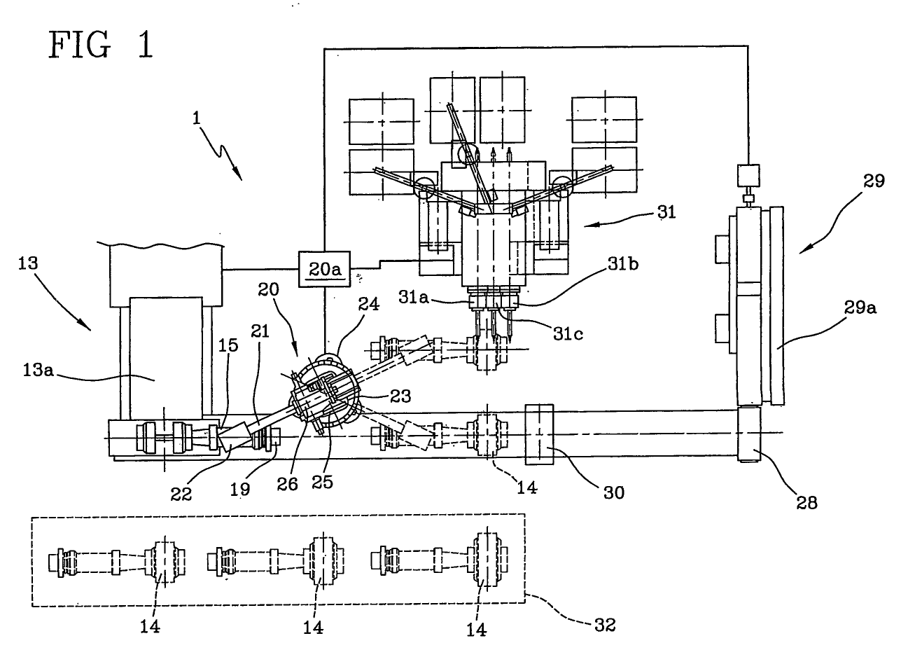

FIG. 1 is a diagrammatic top view of an apparatus for producing tyres in accordance with the present invention;

FIG. 2 is an elevation view of a portion of the apparatus in FIG. 1, highlighting the drum in a building condition and while picking up a belt structure;

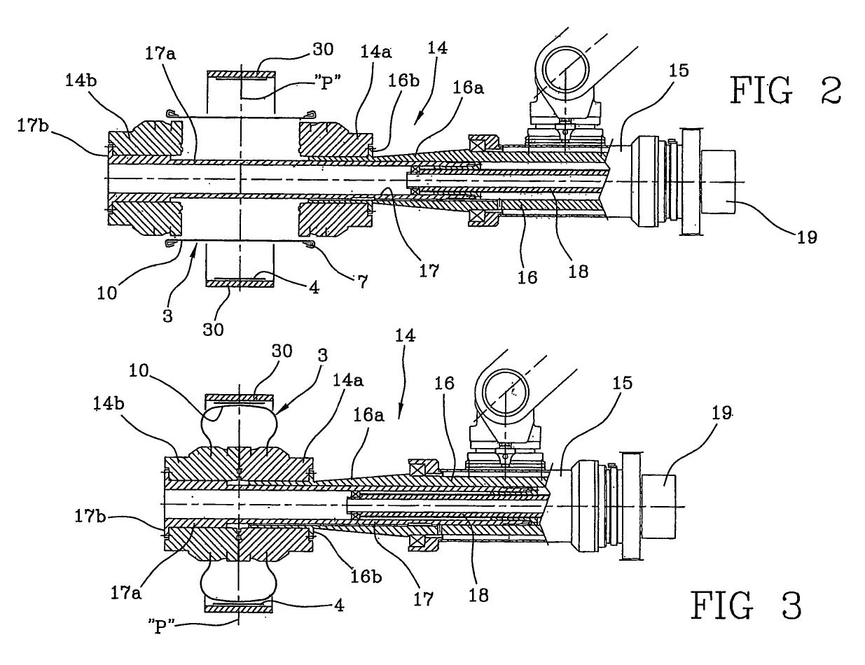

FIG. 3 shows the drum seen in FIG. 2 in a shaping condition;

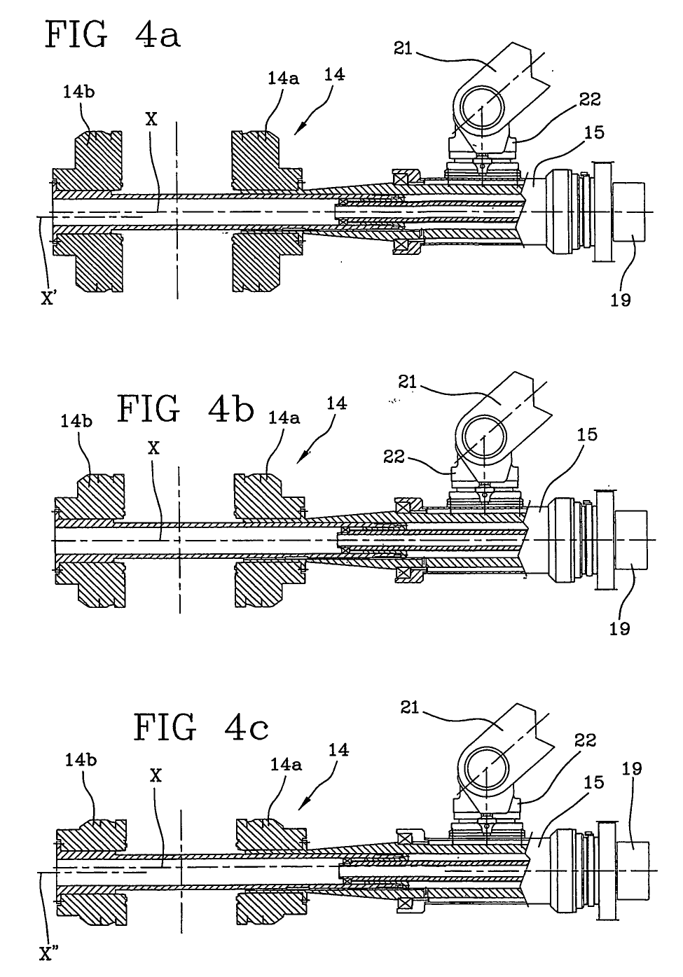

FIGS. 4a, 4b and 4c are comparing diagrams showing angular correction oscillations that can be carried out on the drum in accordance with the present invention;

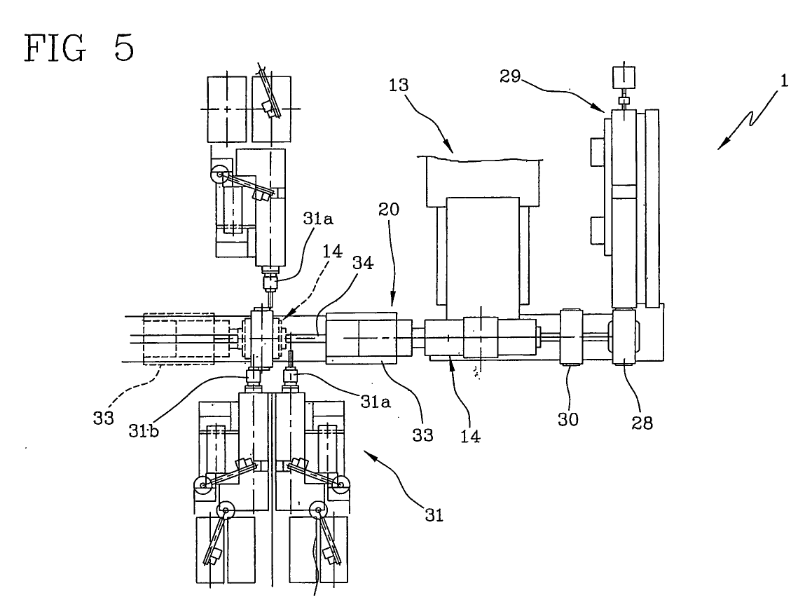

FIG. 5 is a diagrammatic plan view of an alternative embodiment of an installation in accordance with the present invention;

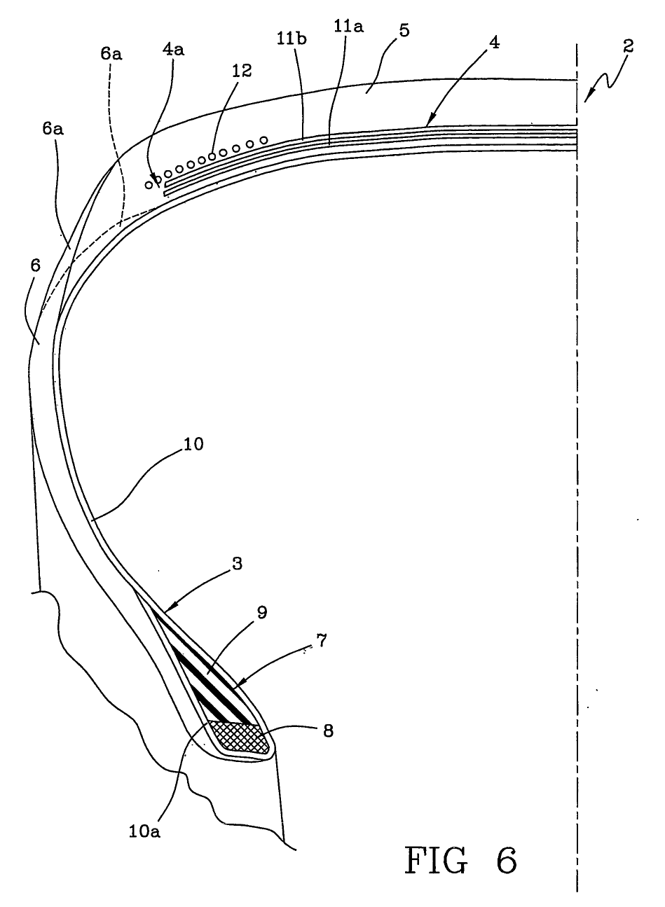

FIG. 6 is a fragmentary diagrammatic cross-section view of a tyre obtainable in accordance with the present invention.

Referring particularly to FIGS. 1 and 5, an apparatus for building tyres for vehicle wheels set to put into practice a building method in accordance with the present invention has been generally identified by reference numeral 1.

The invention aims at producing tyres of the type generally denoted at 2 in FIG. 6, essentially comprising a carcass structure 3 of substantially toroidal shape, a belt structure 4 of substantially cylindrical shape, circumferentially extending around the carcass structure 3, a tread band 5 applied to the belt structure 4 at a circumferentially external position, and a pair of sidewalls 6 laterally applied to the carcass structure 3 on opposite sides and each extending from a side edge of the tread band until a region close to a radially internal edge of the carcass structure itself.

The carcass structure 3 comprises a pair of annular anchoring structures 7 integrated into regions usually identified as “beads” and each consisting of a substantially circumferential annular insert 8 for example, which is usually referred to as “bead core” and carries an elastomeric filler 9 at a radially external position. Turned up around each of the annular anchoring structures are the end flaps 10a of one or more carcass plies 10 comprising textile or metallic cords extending transversely of the circumferential extension of tyre 2, possibly following a predetermined inclination, from one of the annular anchoring structures 7 to the other.

The belt structure 4 may in turn comprise one or more belt layers 11a, 11b including metallic or textile cords that are suitably inclined to the circumferential extension of the tyre, in respectively crossed orientations between one belt layer and the other, as well as a possible outer belting layer 12 including one or more cords circumferentially wound into coils disposed axially side by side around the belt layers 11a, 11b.

Each of the sidewalls 6 and the tread band 5 essentially comprises at least one layer of elastomeric material of suitable thickness. Also associated with the tread band 5 may be a so-called under-layer (not shown) of elastomeric material of suitable composition and physico-chemical features which acts as an interface between the true tread band and underlying belt structure 4.

The individual components of the carcass structure 3 and belt structure 4, such as in particular the annular anchoring structures 7, carcass plies 10, belt layers 11a, 11b and further possible reinforcements designed to constitute the outer belting layer 12, are supplied to apparatus 1 in the form of semi-finished products made during previous working steps, to be suitably assembled with each other.

Apparatus 1 is provided with a feeding station to supply the carcass structure 3 components, which will be referred to in the following as building station 13 and not described in detail as it can be obtained in any convenient manner, said station being set to operate on a drum 14 to dispose the carcass structure 3 thereon.

Drum 14 could be provided to be of the so-called “second stage” type, i.e. set to engage the carcass structure 3 previously made in the form of a cylindrical sleeve on a so-called “building drum” (not shown) associated with the building station 13. However, in accordance with a preferential embodiment shown in the drawings and described in the following of the present specification, drum 14 is of the so-called “unistage” type, i.e. it is set to support the carcass structure 3 over the whole building process of tyre 2, until the latter is removed from the drum itself to be submitted to a vulcanization step.

With use of a drum 14 of the “unistage” type, the step of setting the carcass structure 3 on the drum is carried out by assembling the components of the carcass structure itself directly on drum 14, at the building station 13. For the purpose, the carcass ply or plies 10 are delivered from a feeding line 13a in the form of sections cut to the appropriate length, in connection with the circumferential extension of drum 14, and wound on said drum to form a so-called “carcass sleeve” which is substantially cylindrical. Alternatively, the carcass ply or plies 10 are first delivered and then cut to size when delivery has been completed. Annular anchoring structures 7 are fitted on the end flaps 10a of plies 10. If required, the building station 13 may comprise devices for associating auxiliary inserts such as reinforcing “lunettes” or others for example, with the carcass ply or plies 10, which inserts are applied during preliminary steps or during steps alternated with those of laying the ply or plies 10 and/or other components of the carcass structure 3.

As better viewed from FIGS. 2 and 3, drum 14 comprises a support structure 15 having a cylindrical tubular shape, in which a primary shaft 16 is rotatably in engagement, movement of same being restrained in an axial direction. The primary shaft 16 has an end portion 16a projecting from the support structure 15 in cantilevered fashion and it supports an attachment flange 16b to which a proximal half 14a of drum 14 is fastened. The proximal half 14a is therefore secured in an axial direction relative to the support structure 15.

An auxiliary shaft 17 having an end portion 17a jutting out in cantilevered fashion from the end portion 16a of the primary shaft is in axially slidable engagement with the primary shaft 16 while being restrained from moving in a rotational direction. The extremity of the end portion 17a carries a second attachment flange 17b to which a distal half 14b of drum 14, disposed coaxial and in mirror image relationship therewith, is fastened.

In a manner known by itself, each of the proximal and distal halves, 14a, 14b, has movable parts driven by appropriate actuators not shown, either to enable engagement and disengagement of the annular anchoring structures 7 and/or turning up of the end flaps 10a of the carcass plies during building of the tyre, or to receive a previously formed carcass structure.

Also associated with drum 14 are translation devices acting on the auxiliary shaft 17 to cause mutual moving close of the proximal 14a and distal 14b halves. These translation devices, only diagrammatically shown in the drawings as they can be made in any convenient manner, can comprise a ball-bearing screw 18, fluid-operated actuators, or still other means, for example.

The support structure 15 operates on a actuating unit 20 governed by an electronic control unit 20a monitoring operation of apparatus 1 as a whole.

In a preferential embodiment, the actuating unit 20 helps in governing a robotized arm 21 carrying an end head 22 to which drum 14 is fastened, at the support structure 15.

In the example shown, the robotized arm 21 is inserted in the actuating unit 20 comprising a rotatable base 23 set on a fixed platform 24 and rotating around a first vertical axis, a first section 25 linked to the base 23 in an oscillatable manner around a second preferably horizontal axis, a second section 26 linked to the first section 25 in an oscillatable manner around a third axis which is preferably horizontal too. Said robotized arm 31 is rotatably supported by the second section 26 on an axis orthogonal to the third oscillation axis. Head 22 linked to the robotized arm 21, rigidly engages the support structure 15 with possibility of oscillation around a fifth and a sixth oscillation axes orthogonal to each other.

A motor 19 rigidly fixed to the support structure 15 operates on the primary shaft 16 of drum 14, to simultaneously drive the proximal 14a and distal 14b halves in rotation.

Simultaneously with assembling of the carcass structure 3 on drum 14, manufacture of the belt structure is carried out on an auxiliary drum 28. More particularly, to this aim it is provided that the auxiliary drum 28 should interact with a station 29 for application of the belt structure 4 that can for example comprise at least one feeding line 29a along which semi-finished products in the form of a continuous strip are moved forward, said semi-finished products being then cut into sections of a length corresponding to the circumferential extension of the auxiliary drum 28 concurrently with manufacture of the corresponding belt layers 11a, 11b on the same. Combined with the feeding line for the belt layers 29a is a feeding unit for supply of one or more additional reinforcing inserts, such as continuous cords (not shown in the drawings) to be applied upon the belt layers 121a, 11b to form the external belting layer 12 in the form of axially contiguous circumferential coils.

Upon the action of appropriate transfer devices, the belt structure 4 disposed on the auxiliary drum 28 lends itself to be picked up from the latter and transferred onto the carcass structure 3 disposed on drum 14 in the form of a cylindrical sleeve, as shown in FIG. 2. The transfer devices may for example comprise a transfer member 30 of substantially annular shape that is moved until it sets itself around the auxiliary drum 28 to pick up the belt structure 4 therefrom.

In a manner known by itself, the auxiliary drum 28 disengages the belt structure 4 that is then handled by the transfer member 30 to be placed to an appropriate position for engagement with the carcass structure 3. Upon the action of the actuating unit 20, drum 14 is in turn led to interact with the transfer member 30, starting from the position at which the drum itself co-operates with the building station 13, or other devices adapted to engage the carcass structure 3 thereon.

When the belt structure 4, held by the transfer member 30, is disposed around the carcass structure 3, in coaxial relationship therewith, the latter must be shaped in a toroidal configuration, through mutual axial approaching of the annular anchoring structures 7 and simultaneous admission of pressurized fluid to the carcass structure itself, so that an intermediate portion thereof radially expands until bringing the carcass ply or plies 10 into contact with the inner surface of the belt structure 4.

To this aim, the proximal 14a and distal 14b halves are moved close to each other starting from a building condition at which they are axially spaced apart as shown in FIG. 2 to enable formation of the carcass sleeve of cylindrical shape on drum 14, until a shaping condition at which, as shown in FIG. 3, halves 14a, 14b are axially moved close to each other again, to enable radial expansion of the carcass structure 3. Advantageously, mutual approaching of the proximal 14a and distal 14b halves is carried out by causing, upon the action of translation devices 18 associated with drum 14, an axial sliding of the auxiliary shaft 17 and, therefore, of the distal half 14b towards the support structure 15, whereas the proximal half 14a keeps a fixed axial positioning with respect to the support structure itself.

To allow coupling to take place in a correct manner, the movements of the actuating unit 20 and/or the transfer member 30 are such governed by the control unit 20a that mutual contact between the carcass structure 3 and belt structure 4 takes place at a common meridian plane thereof.

To this aim drum 14, in the building condition, is preferably provided to be coaxially inserted into the transfer member 30, preferably until leading the axial middle plane of the carcass structure 3 to coincide with the axial middle plane of the belt structure 4 in the above mentioned common meridian plane, denoted at “P” in FIGS. 2 and 3. The control unit 20a therefore governs movements of the actuating unit 20 so as to cause a translation of the support structure 15, and therefore the proximal half 14a, towards the distal half 14b. Simultaneously, upon the action of translation devices 18 governed by the control unit 20a as well, the distal half 14b is axially moved towards the support structure 15 by an amount, expressed in terms of stroke and/or speed, proportional to and preferably corresponding to twice the translation carried out by the support structure itself with respect to an axial middle plane identifiable between halves 14a, 14b and coincident with said common meridian plane “P”.

In accordance with a possible alternative embodiment, the control unit 20a may govern movement of the translation devices 18 and the transfer member 30 in such a manner that, starting from an initial reference position at which the axial middle planes of the carcass structure 3 and the belt structure 4 are coincident in the common meridian plane “P, the belt structure 4 is moved to the proximal half 14a and simultaneously, the distal half 14 is moved towards the proximal half 14a itself by an amount, expressed in terms of stroke and/or speed, substantially proportional to and preferably corresponding to twice the translation carried out by the belt structure 4.

A rolling step to be made in any convenient manner can be carried out on the belt structure 4 after the above described shaping step or concurrently therewith, to obtain a better grip of the belt structure 4 against the carcass ply or plies 10.

When engagement has been completed, drum 14 in the shaping condition, together with the carcass 3 and belt 4 structures engaged thereon, is transferred in front of at least one unit 31 for application of at least one elongated element of raw elastomeric material, adapted to make at least one component of said tyre at a position external to the carcass structure 3.

In more detail, the elongated element can be applied in contiguous circumferential coils around a geometric axis of the carcass structure 3, at a position radially external to the belt structure 4 to make the tread band 5 and/or at a position axially external to the carcass structure 3 to make the sidewalls 6.

Preferably, application of the tread band 5 and/or application of the sidewalls 6 are carried out following the above modality, even if the possibility of making the tread band 5 or sidewalls 6 in any other convenient manner is not to be excluded.

The application unit 31 may comprise one or more delivery members 31a, 31b, 31c, each set to lay a respective elongated element of elastomeric material on the carcass structure 3 and/or belt structure 4. Each delivery member 31a, 31b, 31c may for example comprise an extruder, an applicator roller or other member that, when put close to the tyre being processed, lends itself to deliver the respective elongated element directly against the belt structure 4 and/or carcass structure 3 supported by drum 14, simultaneously with winding of the elongated element itself around the geometric axis of the carcass structure 3.

In more detail, a first delivery member 31a can be set to deliver a first elongated element directly against the belt structure 4, to form the tread band 5.

When achievement of the tread band 5 calls for formation of a so-called sub-layer, an auxiliary delivery member 31b can be provided to directly lay an auxiliary elongated element designed to form said under-layer of elastomeric material against the belt structure 4, before intervention of the first delivery member 31a.

Also provided is at least one second delivery member 31c set to deliver a second elongated element directly against the carcass ply 10, simultaneously with rotation of drum 14 allowing winding of the elongated element on the carcass structure 3 supported by said drum 14, at an axially external position.

The actuating unit 20 co-operates with the delivery members 31a, 31b, 31c to define said application unit 31.

Motor 19 in fact operates on drum 14 to drive it in rotation around its geometric axis, so that each of the elongated elements is circumferentially distributed relative to the carcass structure 3. Simultaneously, the actuating unit 20 carries out controlled relative displacements between the drum 14 and the delivery members 31a, 31b, 31c to distribute the elongated element in coils disposed in side by side relationship to form the tread band 5 and/or sidewall 6, in accordance with the desired thickness and geometric-conformation requirements.

The actuating unit 20 therefore lends itself to support drum 14 and guide movement of same during the whole production cycle, being governed by the control unit 20a, which drum is conveniently moved and driven for interaction with the building station 13 and, subsequently, with the parts of apparatus 1 dedicated to carrying out coupling of the belt structure 4 on the carcass structure 3, as well as subsequent formation of the tread band 5 and sidewalls 6.

In more detail the actuating unit 20, after positioning drum 14 in such a manner as to enable engagement of the carcass structure 3 thereon, brings the drum itself to a position coaxial with the transfer member 30 of the belt structure 4. When engagement of the belt structure 4 on the carcass structure 3 has occurred, following shaping of the carcass structure 3 into a toroidal conformation, the actuating unit 20 brings drum 14, by conveniently moving it, in front of the possible auxiliary delivery member 31b designed to make the possible under-layer and, subsequently, in front of the first delivery member 31a, upon the action of which formation of the tread band 5 is completed. Drum 14 is subsequently transferred to the second delivery member 31c and suitably moved in front of the latter to determine formation of one of the sidewalls 6 laterally against the carcass structure 3, just as an indication starting from the annular anchoring structure 7 until close to the corresponding side edge of the previously formed tread band 5. Following overturning of drum 14 in front of the second delivery member 31c, formation of the second sidewall 6 is started on the side of the carcass structure 3 opposite to the previously formed sidewall 6.

The above described operating sequence enables formation of sidewalls 6 having their radially external tailpieces 6a laterally superposed with respect to the side edges of the tread band 5, in accordance with a design scheme of the type usually referred to as “overlying sidewalls”.

However, with the same ease, formation of the sidewalls 6 following a design scheme of the type usually called “underlying sidewalls” can be achieved by submitting drum 14 to the action of the second delivery member 31c to determine formation of the sidewalls 6, before bringing it in front of the possible auxiliary delivery member 31b and the first delivery member 31a to form the tread band 5.

During processing, each of the delivery members 31a, 31b, 31c preferably keeps a fixed positioning, while drum 14 is driven in rotation and suitably moved in a vertical direction by the actuating unit 20 in order to determine a convenient distribution of each elongated element so as to form a layer of appropriate shape and thickness over the carcass structure 3 and/or belt structure 4. The continuous elongated element fed from each of the delivery members 31a, 31b, 31c can advantageously have a flattened section, so that it can modulate the thickness of the thus formed elastomeric layer by varying the overlapping degree of the contiguous coils and/or the orientation of the surface of the tyre being worked with respect to the cross-section profile of the elongated element fed from the delivery member itself.

When manufacture of the tread band 5 and sidewalls 6 has been completed, the actuating unit 20 causes a new translation of drum 14 to move it away from the application unit 31 and position it in front of devices (not shown) designed to disengage the built tyre 2 from drum 14. Subsequently, the actuating unit 20 transfers drum 14 again in front of the building station 13 to enable a new carcass structure 3 to be disposed on the drum itself.

Drum 14 may be advantageously provided to be removably engaged with the end portion 22 of the robotized arm 21, to enable easy replacement of same. In addition, a plurality of drums 14 different from each other may be provided to be associated with apparatus 1, said drums being for example arranged in a magazine 32 for individual engagement by the actuating unit 20, to enable processing of tyres having different dimensional and/or structural features for example.

For the purpose, the actuating unit 20 can be set to interact with magazine 32 to lay down therein the drum 14 in engagement with the end head 22 and replace it with a different drum adapted for processing a different type of tyre.

To ensure a perfect interaction of each drum 14 with the building station 13, the transfer member 30 and all the other members of apparatus 1, an angular correction oscillation of drum 14 may be advantageously provided to be carried out in case of need, to give the geometric drum axis a predetermined orientation. Thus, it is possible to correct any occurring misalignments due for example to the difference in weight between a drum 14 designed to process tyres of relatively small sizes (FIG. 4c) and a drum set to process tyres of important tyres (FIG. 4a).

Through comparison of FIGS. 4a, 4b and 4c it can be easily understood that drum 14, by means of slight angular movements transmitted through the actuating unit 20, can easily compensate for any deviation exhibited by axis X of drum 14 with respect to a correct angular orientation. In particular, starting from a supposed condition in which the actuating unit 20 maintains the correct angular orientation of a drum 14 of medium sizes, as in FIG. 4b, should this drum be replaced with a drum 14 of greater sizes, as in FIG. 4a, orientation of the geometric axis X of the new drum, by effect of a greater weight, would tend to be deviated downwards to the position denoted at X′ in FIG. 4a. This deviation however can be easily corrected by imparting a slight angular correction oscillation to drum 14 in a clockwise direction relative to FIG. 4a, through the actuating unit 20.

Vice versa, when drum 14 is replaced by a drum of smaller sizes, as in FIG. 4c, orientation of the geometric axis X of the new drum, by effect of a smaller weight, would tend to deviate upwardly to the position denoted at X″ in FIG. 4c. This deviation is corrected by imparting a slight angular correction oscillation in a counterclockwise direction relative to FIG. 4c to drum 14.

To carry out an angular correction oscillation in an automatic and precise manner, an identification code may be provided to be associated with each drum 14; said code may be stored for example on a small memory unit or may comprise bar codes, mechanical references or others, adapted to be detected by an appropriate system enabling the electronic control unit 20a to recognize the type of drum 14 engaged on said end head 22. Also stored in the control unit 20a can be a series of angular correction values each combined with one of the identification codes of drums 14 provided in apparatus 1. On detection of the identification code of the drum 14 associated with the actuating unit 20, a selection unit associated with the control unit 20a selects the angular correction value combined therewith, in response to which the control unit commands the consequent angular correction oscillation through the actuating unit 20, to give the drum 14 the preestablished orientation.

As an alternative to the above, for control of the angular correction oscillation use of devices for detecting the orientation of drum 14 may be provided, which devices comprise photoelectric cell detectors or others for example, adapted to transmit a signal to the control unit 20a that corresponds to the angular orientation taken by the drum 14 associated with the actuating unit 20. A comparator associated with the control unit 20a compares the detected orientation with a predetermined orientation value, stored in the control unit itself. When the detected orientation value diverges from the predetermined value more than a given tolerance threshold, the control unit 20a commands carrying out of the angular correction oscillation.

In a possible alternative embodiment shown in FIG. 5, the actuating unit 20 comprises a carriage 33 movable along a guide structure 34, between a first position at which, as shown in solid line, it supports drum 14 in front of the building station 13, and a second position at which, as shown in chain line, it supports drum 14 close to the unit 31 for application of the elongated element. In this case the presence of at least two extruders or other delivery members 31c designed to form the sidewalls may be provided, which delivery members are possibly radially and/or transversely movable with respect to the geometric axis of the carcass structure 3 to determine distribution of the respective elongated elements in coils disposed radially in side by side relationship against the opposite sides of the carcass structure 3 under production.

According to a further alternative embodiment, to be adopted in anyone of the above described examples, the delivery member or members 31a, 31b, 31c may be provided to be moved transversely of the circumferential extension of the carcass structure 3 and/or belt structure 4, to determine the transverse distribution of the coils formed with the continuous elongated element.

The present invention achieves important advantages.

Elimination of the mobility of the proximal half 14a of drum 14 in favour of doubling of the stroke performed by the distal half 14b in fact, has allowed achievement of a surprising structural simplification and weight reduction in drum 14, so that it has become suitable for being governed by a robotized apparatus or the like. The invention also utilises the mobility of the actuating unit 20 and/or transfer member 30 of the belt structure 4 to ensure engagement of the carcass structure 3 with the belt structure 4 to an axially centred position, without undesirable misalignment in the assembling operation being caused due to lack of mobility of the proximal half 14a of drum 14.

The invention also enables an easy replacement of the employed drum 14, so that the installation can be instantaneously adapted to the production of tyres having structural features and/or sizes different from each other. This possibility is still more advantageous because it is exploited in combination with formation of the tread band 5 and/or sidewalls 6 by winding of the continuous elongated element supplied from the application unit 31 into contiguous coils, which is readily adaptable to production of tyres of any shape and/or size.

Formation of the tread band 5 and/or sidewalls 6 by winding of a continuous elongated element into coils disposed in side by side relationship also enables overcoming of all the limits of the known art correlated with the requirement of using complicated and bulky machinery for producing tread bands and sidewalls by extrusion, the investment and operating costs of which only justify a large-scale production.

On the contrary, the invention enables the tread band and sidewalls to be produced with much simpler and less bulky machinery, suitable for a production in compliance with the productivity of the individual apparatus 1.

1-25. (canceled)

26. A method for producing a tyre for a vehicle wheel, comprising:
disposing a carcass structure, having a cylindrical-sleeve shape, on a drum having a distal half and a proximal half;
disposing a belt structure coaxially around the carcass structure;
moving the distal and proximal halves mutually close, from a building condition to a shaping condition, until an intermediate portion of the carcass structure contacts an inner surface of the belt structure; and
transferring the drum, in the shaping condition, to a vicinity of at least one application unit;
wherein the distal and proximal halves are both carried by a support structure,
wherein during moving the distal and proximal halves mutually close, the proximal half maintains a fixed axial position with respect to the support structure,
wherein moving the distal and proximal halves mutually close causes radial expansion of the intermediate portion of the carcass structure, and
wherein the at least one unit applies at least one elongated element of elastomeric material, in circumferential coils, to form at least one component of the tyre external to the carcass structure.

27. The method of claim 26, wherein moving the distal and proximal halves mutually close comprises:
translation of the support structure toward the distal half; and
translation of the distal half toward the support structure;
wherein the translation of the distal half toward the support structure is proportional to the translation of the support structure with respect to a median plane between the distal and proximal halves.

28. The method of claim 27, wherein the translation of the distal half toward the support structure is twice as great as the translation of the support structure with respect to the median plane between the distal and proximal halves.

29. The method of claim 26, wherein moving the distal and proximal halves mutually close comprises:
translation of the belt structure toward the support structure; and
translation of the distal half toward the support structure;
wherein the translation of the distal half toward the support structure is substantially proportional to the translation of the belt structure toward the support structure.

30. The method of claim 29, wherein the translation of the distal half toward the support structure is twice as great as the translation of the belt structure toward the support structure.

31. The method of claim 27, wherein the translation of the support structure is carried out through an actuating unit carrying the support structure.

32. The method of claim 26, further comprising:
carrying out an angular-correction oscillation of the support structure to dispose a geometric axis of the drum in a preset orientation;
wherein the preset orientation is coincident with a geometric axis of the belt structure.

33. The method of claim 32, further comprising:
acquiring identification data of the drum;
selecting, from a plurality of preset angular-correction values, a value that depends on the acquired identification data; and
carrying out the angular-correction oscillation in conformity with the selected value.

34. The method of claim 32, further comprising:
detecting an orientation of the geometric axis of the drum;
comparing the detected orientation with a value of the preset orientation; and
carrying out the angular-correction oscillation when the detected orientation diverges from the value of the preset orientation by more than a predetermined tolerance threshold.

35. The method of claim 26, wherein the at least one component comprises a tread band, and
wherein the at least one unit applies the at least one elongated element at a position radially external to the belt structure.

36. The method of claim 26, wherein the at least one component comprises sidewalls, and
wherein the at least one unit applies the at least one elongated element at a position axially external to the carcass structure.

37. The method of claim 26, wherein disposing the carcass structure on the drum comprises:
assembling components of the carcass structure on the drum.

38. The method of claim 26, wherein before disposing the carcass structure on the drum, the drum is transferred to a feeding station for components of the carcass structure.

39. An apparatus for producing a tyre for a vehicle wheel, comprising:
a drum having a distal half and a proximal half;
transfer devices to dispose a belt structure coaxially around a carcass structure on the drum, the carcass structure having a cylindrical-sleeve shape;
translation devices to move the distal and proximal halves mutually close, from a building condition to a shaping condition; and
at least one unit for applying at least one elongated element of elastomeric material, in circumferential coils, to form at least one component of the tyre;
wherein the distal and proximal halves are both carried by a support structure, and
wherein the proximal half is axially fixed with respect to the support structure.

40. The apparatus of claim 39, further comprising:
a feeding station to supply components of the carcass structure;
wherein the feeding station interacts with the drum to form the carcass structure on the drum.

41. The apparatus of claim 39, further comprising:
an actuating unit carrying the support structure; and
a control unit operating on the actuating unit and the translation devices;
wherein the control unit causes:
translation of the support structure toward the distal half; and
simultaneous translation of the distal half toward the support structure; and
wherein the translation of the distal half toward the support structure is proportional to translation of the support structure with respect to a median plane between the distal and proximal halves.

42. The apparatus of claim 41, wherein the control unit is programmed so that the translation of the distal half toward the support structure is twice as great as the translation of the support structure with respect to the median plane between the distal and proximal halves.

43. The apparatus of claim 41, wherein the actuating unit comprises a robotized arm supporting the drum.

44. The apparatus of claim 43, wherein the drum is removably associated with the robotized arm.

45. The apparatus of claim 43, further comprising:
a control unit operating on the actuating unit to submit the drum to an angular-correction oscillation to dispose a geometric axis of the drum in a preset orientation;
wherein the preset orientation is coincident with a geometric axis of the belt structure.

46. The apparatus of claim 45, wherein the control unit comprises:
a memory containing a plurality of angular-correction values each related to identification data of a drum associated with the robotized arm;
an acquisition block to acquire the identification data of the drum associated with the robotized arm; and
a selecting unit to select, from the plurality of angular-correction values, a value corresponding to the acquired identification data;
wherein the control unit carries out the angular-correction oscillation in response to the value selected by the selecting unit.

47. The apparatus of claim 45, further comprising:
a device detecting an orientation of the drum; and
a comparator to compare the detected orientation with the preset orientation;
wherein the control unit carries out the angular-correction oscillation when the detected orientation diverges from the value of the preset orientation by more than a predetermined tolerance threshold.

48. The apparatus of claim 39, further comprising:
an actuating unit carrying the support structure; and
a control unit operating on the actuating unit and the translation devices;
wherein the control unit causes:
translation of the belt structure toward the support structure; and
simultaneous translation of the distal half toward the support structure; and
wherein the translation of the distal half toward the support structure is substantially proportional to the translation of the belt structure toward the support structure.

49. The apparatus of claim 48, wherein the control unit is programmed so that the translation of the distal half toward the support structure is twice as great as the translation of the belt structure toward the support structure.

50. The apparatus of claim 48, further comprising:
a plurality of drums different from each other to be brought individually in engagement with the actuating unit.

51. The apparatus of claim 48, wherein the actuating unit comprises a robotized arm supporting the drum.

52. The apparatus of claim 51, wherein the drum is removably associated with the robotized arm.

53. The apparatus of claim 51, further comprising:
a control unit operating on the actuating unit to submit the drum to an angular-correction oscillation to dispose a geometric axis of the drum in a preset orientation;
wherein the preset orientation is coincident with a geometric axis of the belt structure.

54. The apparatus of claim 53, wherein the control unit comprises:
a memory containing a plurality of angular-correction values each related to identification data of a drum associated with the robotized arm;
an acquisition block to acquire the identification data of the drum associated with the robotized arm; and
a selecting unit to select, from the plurality of angular-correction values, a value corresponding to the acquired identification data;
wherein the control unit carries out the angular-correction oscillation in response to the value selected by the selecting unit.

55. The apparatus of claim 53, further comprising:
a device detecting an orientation of the drum; and
a comparator to compare the detected orientation with the preset orientation;
wherein the control unit carries out the angular-correction oscillation when the detected orientation diverges from the value of the preset orientation by more than a predetermined tolerance threshold.
